(19) United States
(12) Patent Application Publication
(10) Pub. No.: US 2010/0315653 A1
(43) Pub. Date: Dec. 16, 2010

(54) OPTICAL SENSOR FOR POSITIONING TASKS

(76) Inventors: Thomas Weingartz, Norvenich (DE); Johannes Gromke, Mehmann (DE)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/664,663

(22) PCT Filed: Jun. 18, 2008
(86) PCT No.: PCT/EP2008/057708

§ 371 Date: Aug. 26, 2010

(30) Foreign Application Priority Data
Jun. 22, 2007 (DE) 10 2007 029 299.8

(51) Int. Cl. G01B 11/14

(52) U.S. Cl. 356/620

(57) ABSTRACT

The invention relates to a method for length and/or velocity measurement, in particular for positioning tasks, in which an optical sensor carries out a length and/or velocity measurement on a measurement object in a contactless manner, wherein the optical sensor carries out the length and/or velocity measurement via an image processing method, via a spatial frequency filter method and/or by way of a laser Doppler method and reference markings are recognized by the optical sensor, and to a corresponding apparatus. The object of providing a simple method and a simple apparatus for length and/or velocity measurement which offers a higher degree of measurement reliability with the result that it can also be used in safety-relevant areas of application is achieved by evaluation means carrying out reference marking recognition operations and by a plausibility test being carried out, in which a signal is generated as a function of the result of the plausibility test.

The invention relates to a method for length and/or speed measurement, in particular for positioning tasks, in which an optical sensor carries out a length and/or speed measurement on a measurement object in a contactless manner, the optical sensor carrying out the length and/or speed measurement via an image processing method, via a spatial frequency filtering method or by way of a laser Doppler method and reference markings being recognised by the optical sensor. In addition, the invention relates to a device for contactlessly measuring lengths and/or speeds of a measurement object, in particular for carrying out positioning tasks, comprising at least one optical sensor, the optical sensor carrying out a contactless length and/or speed measurement, wherein the optical sensor can be used to carry out an image processing method, a spatial frequency filtering method or a laser Doppler method for length and/or speed measurement, and evaluation means being provided that allow reference markings to be recognised.

Optical sensors are increasingly used for measuring lengths and/or speeds of measurement objects. For example, optical sensors can be used to calculate speeds and distance advancement of vehicles relative to the ground, the actual measurement object. They offer the advantage of allowing a length and/or speed measurement to be contactlessly carried out solely via features of the surface over which the sensor, for example, moves. To this extent, an additional installation of distance or signal-outputting means is in principle not required in order to calculate the position of an optical sensor. Optical sensors for length and/or speed measurement preferably apply the image processing method, the spatial frequency filtering method and/or the laser Doppler method. In the laser Doppler method, a laser beam is divided into two partial beams via a beam splitter and both partial beams are brought into interference at various angles on the surface of the measurement material. Both laser beams now experience, owing to the speed of the sensor in relation, for example, to the ground, a different Doppler shift, i.e. a frequency shift as a function of the relative speed. The low-frequency beat frequency contained in the scattered laser light is, in the first order, directly proportional to the speed of the sensor in relation to the measured object or the surface thereof. An optical sensor which applies the spatial frequency filtering method calculates the speed and, from this, the correspondingly covered length from the frequency at which the optical elements of the sensor measure identity fluctuations. The sensor applying the image processing method calculates the speed and, from this, the length covered from the comparison between images or brightness patterns recorded at different times on the light-sensitive elements of the optical sensor. Object features of the object surface, the speed of which is to be measured, are therefore calculated and the movement thereof is determined by forming a correlation function between images of different points in time. Increasingly, optical sensors are also being used to perform positioning tasks in which it is necessary to exactly determine a position. Merely the three methods described all have in this connection the property of being able to calculate only a relative distance advancement without an absolute relationship being established between the reference system of the sensor and the reference system of the measurement object. This fact has serious drawbacks in positioning tasks. For example, a power failure can lead to position information no longer being present, in particular when, in the voltage-free state, a relative movement occurs between the sensor and measurement object. A cause of a further drawback is, for example, the fact that the measurement errors of the device, which occur in each measured advancement step, are accumulated over relatively long distances without being able to be corrected. The sensor's recognition of reference marks which are fixed on the measurement object allows, conversely, the establishment of an absolute relationship between the spatial system of the sensor and the reference system of the measurement object that eliminates many drawbacks of relative distance measurement.

In addition, it is known from the German patent application having the filing number 10 2005 040 772, which has been laid open for public inspection and originates from the applicant, that optical sensors use reference markings in order in a simple manner to reference the sensor and to determine the position thereof. The aforementioned Offenlegungsschrift proposes that, for example in a sensor using the image processing method, a pattern recognition of the reference marking take place and be used for referencing. Nevertheless, a pattern recognition for recognising the reference markings is time-consuming and requires a high degree of computing effort. Finally, the recognition of reference markings by sensors is known, for example for driverless transport vehicles or elevator controllers, wherein in the past the reference markings were recognised either non-optically, i.e. for example magnetically, or using a separate optical sensor which was unable to carry out a length and/or speed measurement.

Furthermore, a device for length and/or speed measurements that can also recognise reference markings is known from US patent application US 2004/0221790 A1. Although the US patent application proposes using reference markings to improve the accuracy of the position indication, a use of the known device in safety-related areas of application usually founders on the lack of precautionary measures with regard to faults of the sensors.

Starting therefrom, the present invention is based on the object of providing a simple method and a simple device for length and/or speed measurement that offers a higher degree of measurement reliability, so that the device can also be used in safety-related areas of application.

For a method of the type in question, the above-deduced object is achieved in that evaluation means carry out a reference marking recognition and a plausibility test is carried out in which a signal is generated as a function of the result of the plausibility test.

In contrast to the previously known solutions from the prior art, the device according to the invention allows the carrying-out of plausibility tests which can be used to display fault conditions of the sensors. For example, this allows an error signal to be generated in the case of a non-recognised reference marking after a specific distance advancement. At the same time, a “positive” recognition signal can of course also be generated in the event of positive reference marking recognition. For example, it is possible to carry out, as a function of the result of the plausibility test, further measurements or tests, in particular a check of any light source or the like that is present.

According to a subsequent embodiment of the method according to the invention, an optical and/or acoustic signal display preferably takes place. Faults, but also a regular operation, can be signalled in a manner which is easily recognisable for the users of the devices by way of optical signal displays, for example a red LED or lamp. Acoustic warning sounds are also suitable for this purpose.

According to a further embodiment of the method according to the invention, for position determining or for determining the distance advancement of the sensor relative to the measurement object, evaluation means are used to generate values for at least one counter that correspond to the distance advancement and/or the position of the sensor relative to the measurement object. For example, the values of two counters can correspond to values of a Cartesian coordinate system, so that a simple position determination can be carried out from the counter values. A linear position determination from the altered counter values in the case of just one counter is also conceivable. The values of the counters are constantly newly generated or altered during a movement of the sensor. The at least one counter can be provided both internally with the evaluation means and externally.

Preferably, an optical sensor using the image processing method calculates the values for at least one counter from the correlation of at least two temporally successive images so that it is possible to determine a distance advancement or to determine a position at an equipment complexity that is as low as possible. The term “temporally successive images” refers on the one hand to immediately successive images, but generally to images at various points in time.

According to a subsequent advantageous embodiment of the method according to the invention, in order to further improve the accuracy of the position determination using an optical sensor for length and/or speed measurement, the positions of the reference markings are filed in a value table and the value table is used for carrying out a plausibility test. The value table can be provided internally with the evaluation means or externally.

Preferably, at least the current, measured position of the optical sensor relative to the measurement object is compared to positions in the value table during the plausibility test, so that the test can be carried out particularly simply and rapidly. The current, measured position of the optical sensor corresponds, for example, to the value of the counter. In addition, the plausibility test, which is for example carried out on reaching a reference marking, makes it possible to ensure that the currently measured position provided by the counter value is corrected with the positions which, according to the value table, have actually been reached. This allows the accuracy of the length and/or speed measurement to be increased, as the measurement errors accumulated via the previous distance advancement in the counter value are substantially eliminated.

If the plausibility test is carried out periodically over time, periodically after a specific distance advancement and/or on recognition of a reference mark, the operational safety and accuracy of the length and/or speed determination can be further improved.

A particularly simple recognition of fault conditions of the device is achieved in that the deviation of the counter values from the actual position of the optical sensor or the device is used as a measure of the presence of a fault. The ascertainment of the actual position is made possible by the recognition of reference markings, as these are fixed on the measurement object. The ascertainment and monitoring of the deviation can take place periodically over time, periodically after a specific distance advancement and/or on recognition of a reference mark. The value table informs the device at what counter values the recognition of a reference marking is to be expected. The deviation of the counter values from the actual position can be ascertained, for example, in that a reference marking is recognised at a counter value which is not stored in the value table. Furthermore, a deviation can be ascertained, for example, in that no reference marking is detected in a counter value stored in the value table.

If the extent of the deviation can be variably set for recognising a fault, it is possible to react to accuracy and safety requirements in a particularly application-specific manner.

The method according to the invention allows a controller, for example of a driverless transport vehicle, to be activated in a simple manner in that the result of the plausibility test is transmitted via digital outputs. This also allows further information about the state of the device to be transmitted.

According to a subsequent developed embodiment, the reference markings are assigned in a teach-in method to positions measured by the optical sensor and are filed in a value table. The teach-in method can not only include the assignment of the measured position to a specific reference marking; it is also possible to assign additionally characteristic features of the reference marking to the measured position, so that the reference markings can be uniquely recognised. This allows an entirely absolute spatial relationship between the position of the sensor and the position of the measurement object to be achieved. For example, an optical sensor using the image processing method can be used to file the characteristic pattern of a reference marking. The same also applies to the laser Doppler or spatial frequency filtering method. It is conceivable to achieve, in the latter methods via reference markings with regions of different reflective properties, a characteristic signal change of the laser Doppler signal of the spatial frequency filtering method.

Although it is in principle possible to arrange the reference markings in any desired manner, it is advantageous to arrange them linearly and/or in a two-dimensional point raster and/or to form them as line rasters. In a linear arrangement, it is possible to calculate, for example by measuring a distance between two reference markings, the positions of the remaining reference markings and to file them, for example, in the value table.

In addition, the absolute position of a reference marking can easily be assigned in that the reference markings are additionally coded, in particular uniquely coded. For example, it is possible to assign absolute positions to the coded signals via a simple value table, so that the measured absolute position can be compared to the actual position of the reference marking immediately on recognition of a coded or uniquely coded reference marking.

Preferably, the images of a reference marking that are determined by an optical sensor are transmitted to additional internal and/or external evaluation means for reference marking recognition, so that an accelerated reference marking recognition takes place based on the parallel processing of the data. The reference marking recognition is based in this case conventionally on a pattern recognition which can also be carried out internally within the evaluation means.

According to a subsequent embodiment of the method according to the invention, the reference markings cause a significant alteration of the amount of light and/or light intensity measured by the optical sensor, so that reference markings are recognised by the optical sensor via the change in the amount of light or light intensity. It has been found that a significant change in the amount of light and/or light intensity measured by the optical sensor can be recognised particularly rapidly and evaluated in a correspondingly rapid and simple manner irrespective of the type of method used for the length and/or speed measurement. The term “a significant change in the measured amount of light and/or light intensity” is regarded in the present document as referring to a change in the amount of light or light intensity of more than 20%. The method according to the invention is thus very well suited for positioning tasks, in particular, since, as a result of the rapid reference marking recognition, an exact position determination takes place promptly and the speed with which the positioning tasks, for example of a driverless vehicle, can be completed can thus be increased.

According to a first embodiment of the method according to the invention, the reference markings have light-reflecting, in particular mirroring surface regions and/or surface regions which strongly absorb and/or transmit light. These regions allow the amount of light or light intensity measured by the sensor to be altered in a particularly simple manner, for example if the sensor has its own light source for illuminating a measurement object, in order to recognise a reference marking. The strongly absorbing surfaces used may, for example, be matt-black surfaces. Transmitting surface regions are distinguished in that irradiated light is not reflected and thus not measured by the sensor. They reduce the amount of light or light intensity measured by the optical sensor. Transmitting surface regions can be provided, for example, simply by way of holes or gaps arranged on the measurement object. Strongly reflecting surface regions markedly increase the measured amount of light or light intensity compared to the remainder of the measurement object surface, so that a simple reference marking recognition is ensured in this way too.

According to a second teaching of the present invention, the above-identified object is achieved by a device of the type in question in that the evaluation means can be used to carry out a plausibility test and a signal can be generated as a function of the result of the plausibility test.

As previously stated, the device according to the invention allows safety-relevant areas of application to be opened up at low equipment complexity, as the possibility of carrying out plausibility tests allows fault conditions of the device to be rapidly recognised.

Preferably, an optical and/or acoustic fault display is provided. The signal display can be used to signal both a fault and a trouble-free working state of the device.

According to a subsequent embodiment of the device according to the invention, evaluation means are provided that provide at least one counter, the values of which correspond to the distance advancement and/or the position of the sensor relative to the measurement object, so that the current, measured position or counter values can be compared in a simple manner to predefined values, for example of reference markings. The predefined values are entered in a value table.

According to a further embodiment, a device according to the invention can provide a teaching-in of reference markings in a teach-in mode in that positions of reference markings can be calculated from the counter values via the evaluation means and be filed in a value table. In this mode, measured positions or counter values but also characteristic measurement signals, for example for pattern recognition, which were measured by the optical sensor, can therefore be assigned to the reference markings.

A particularly simple plausibility test can be provided in that a plausibility test, in which at least the respective position is compared to positions filed in the value tables, can be carried out via the evaluation means. The determined deviation can then be used as a measure of the presence of a fault.

If the optical sensor has at least one digital output, it is possible to output in a simple manner to an external control unit a signal which transmits, for example, the result of the plausibility test to a controller. However, it is also possible for further state information to be transmitted.

Preferably, reference markings are provided that cause a significant alteration of the amount of light or light intensity measured by the sensor, and the reference markings can be recognised by the evaluation means via the change in the amount of light or light intensity. As stated hereinbefore, reference markings which significantly alter the amount of incident light can be recognised particularly rapidly and simply via the measurement of the amount of incident light. To this extent, a corresponding device does not require any complex evaluation means either and can nevertheless increase the accuracy of the length and/or speed measurement by using the reference markings.

Finally, the device according to the invention can be further improved in that coded, in particular uniquely coded, reference markings are provided. This allows preferably absolute positions to be assigned to the, in particular uniquely coded, reference markings, so that these can be used for referencing or, in the case of relatively high deviations, also for introducing a plausibility test.

Now, there are a large number of possibilities for developing and for configuring the method according to the invention for length and/or speed measurement and also the corresponding device. For this purpose, reference is made on the one hand to the patent claims dependent on patent claims 1 and 17, and on the other hand to the description of two exemplary embodiments of the device according to the invention in connection with the drawings, in which:

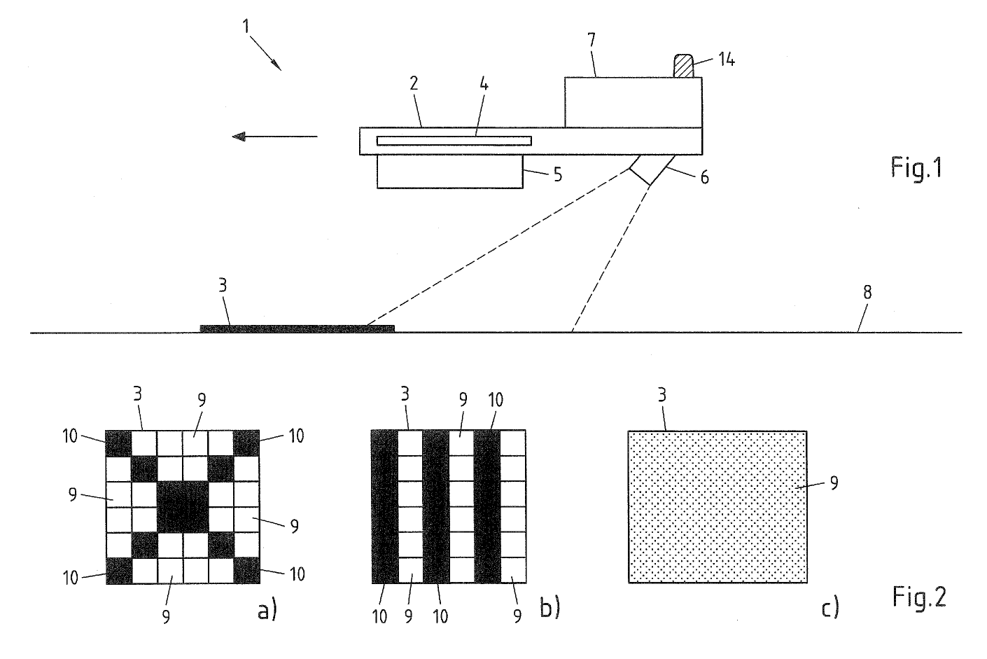

FIG. 1 is a schematic side view of a first exemplary embodiment of a device according to the invention;

FIGS. 2a) to 2c) are plan views of three exemplary embodiments of reference markings according to the invention; and

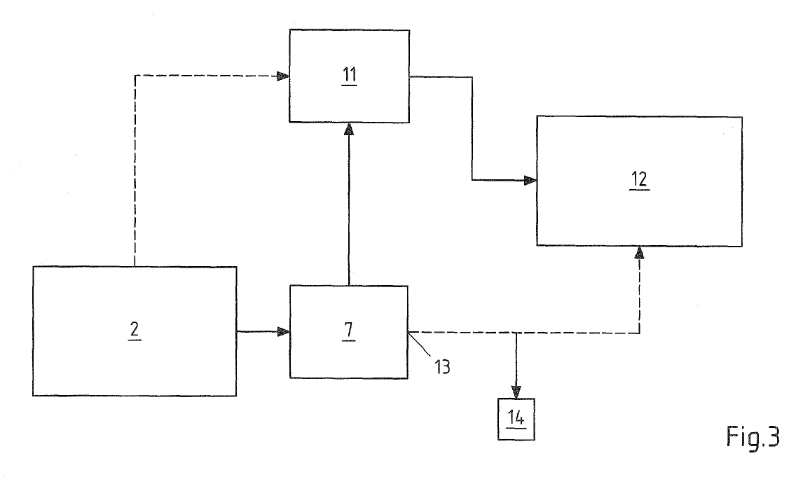

FIG. 3 is a schematic circuit diagram of a second exemplary embodiment of a device according to the invention.

FIG. 1 is a schematic side view of a first exemplary embodiment of a device according to the invention for contactlessly measuring lengths and/or speeds. The device 1 according to the invention comprises an optical sensor 2 and reference markings 3. In the present exemplary embodiment, the optical sensor 2 is, for example, embodied as an optical sensor using the image processing method. In the present exemplary embodiment, the optical sensor 2 has, for example, a two-dimensional array made up of light-sensitive elements 4 with associated imaging optics 5. However, instead of an array, two lines, arranged at an angle, for example arranged perpendicularly to each other, of light-sensitive elements or other detectors can also be used. Moreover, the imaging optics 5 are also merely optional.

In addition, in the present exemplary embodiment, the device has an optional light source 6 which can, for example, be formed by light-emitting diodes, so that the exemplary embodiment according to the invention is independent of extraneous light. Evaluation means 7, which evaluate the information supplied by the array 4, are illustrated schematically in the present exemplary embodiment. The optical sensor 2 is now moved via a surface 8 of a measurement object. During the movement, the evaluation means generate or constantly vary, for example, values of two counters, the change thereof corresponding to the distance advancement of the measurement object relative to the sensor in two different spatial directions, for example in directions lying orthogonally to each other. It is also conceivable for a single counter to be used in a movement in just one spatial direction. The counters can preferably be provided via the evaluation means 7. It is however also conceivable to output the counter values via a data output and to process them externally.

On reaching the reference marking 3, the amount of light or light intensity measured by the optical sensor is changed significantly, as the reference markings 3 reflect, for example, the light irradiated by the light source 6 more strongly than the remaining regions of the surface 8, so that the reference marking 3 can easily be recognised via the evaluation means 7. For example, the reaching of the reference marking 3 can be output to a controller 12 or displayed to a controller via a digital output. A particularly advantageous effect is provided by the light source 6 which is arranged in the present exemplary embodiment and directly ensures that a reference marking 3 leads to a significant rise in the measured amount of light or light intensity in the optical sensor 2 even in the case of low extraneous light.

In addition, on reaching the reference markings 3, the counter values, which correspond to the distance advancement of the device according to the invention and/or the position thereof, can be filed in a value table. The value table can, for example, be provided in a memory module of the evaluation means 7 but also spatially outside the evaluation means, for example in an external evaluation entity 11. In principle, this makes it possible to teach-in the positions, preferably absolute positions, of the reference markings.

When the optical sensor reaches a reference marking 3, it is possible to carry out via the evaluation means 7 a plausibility test in which, for example, the measured position of the sensor as provided by the counter values is compared to the actual position of the sensor that is provided by the position of the reference mark and the corresponding value filed in the value table. The optical/acoustic signal display 14 is activated as a function of the result of the plausibility test and an optical and/or acoustic signal is generated, for example in the case of a fault.

The device according to the invention achieves, via the checking of its own state by means of the plausibility test, a particularly high degree of safety during operation, so that the device can also be used in safety-relevant applications.

Now, FIGS. 2a) to 2c) are plan views of different exemplary forms of the reference markings 3. The reference markings 3 have regions 9 possessing particularly good reflective properties for light. These regions can be embodied, for example, as mirroring regions or as reflector surfaces. The regions 9 can, for example, be formed by a roughened metal surface but also by mirror-coated surface regions. The regions 9 of the reference marking 3 ensure that the optical sensor 2 measures a much higher light intensity or amount of light on reaching a reference marking, so that the reference marking 3 can rapidly be recognised.

The reference markings can have, as shown in FIG. 2a) and FIG. 2b), characteristic patterns by which the reference markings are coded. It is however also possible, as shown in FIG. 2c), to form the reference marking 3 by a single region 9 which has very good reflective properties. Conversely, it is also conceivable for a corresponding marking to cause precisely the opposite, namely a marked reduction of the measured light intensity, for example by way of strongly light-absorbing surfaces. This can, for example, be achieved in that the reference markings 3 have regions 10 having a very high absorbing capacity, for example matt-black regions. As previously stated, the strongly light-absorbing regions can also be implemented by, for example, depressions or holes, gaps in the ground.

FIG. 3 is a schematic circuit diagram of a second exemplary embodiment of the device according to the invention for length and/or speed measurement. The measurement signals generated by the optical sensor 2 are forwarded to the evaluation means 7 which generate corresponding counter values in order to determine the distance advancement and/or the position of the device. In an optical sensor using the image processing method, this is, for example, achieved by correlation of at least two temporally successive images.

According to the invention, when a reference marking 3 is reached, the measured amount of light and/or light intensity is changed significantly. Preferably, the evaluation means 7 then carry out a plausibility test. In this test, the counter values corresponding to the current measured position, which values correspond for example to a position of the device in a Cartesian coordinate system, are, for example, compared to actual positions filed in a value table for the reference markings. If the counter values do not correspond, on reaching a reference marking 3, to the values filed or stored in the value table, a signal can be sent via the digital output 13 to an external controller 12 and also to an optical and/or acoustic signal display 14. The control unit 12 may, for example, be a control unit of a driverless vehicle.

It may also be beneficial, if the speed is known, to carry out plausibility tests periodically over time or after a specific distance advancement in order to increase the accuracy of a length measurement.

Furthermore, it is possible to provide a superordinate evaluation entity 11 to which the images of the optical sensor 2 that are forwarded to the evaluation means 7 can be sent. This allows, for example, an independent pattern recognition to take place in order to uniquely recognise coded reference markings 3. If the reference markings 3 are coded and assigned to positions, i.e. to counter values of a value table, a simple comparison between the current counter values and the actual position of the respective reference marking 3 is possible. This makes it possible to determine very accurately the actual position of the device and to carry out, for example, a correction of the counter values.

In addition, the superordinate evaluation entity 11 can also provide the control unit 12 with data concerning the reaching of a reference marking or the reaching of a coded reference marking.

1.-22. (canceled)

23. A method for length and/or speed measurement, in particular for positioning tasks, wherein an optical sensor carries out a length and/or speed measurement on a measurement object in a contactless manner, the optical sensor carrying out the length and/or speed measurement via an image processing method, via a spatial frequency filtering method or by way of a laser Doppler method and reference markings being recognised by the optical sensor, evaluation means carrying out a reference marking recognition and, the evaluation means generate values for at least one counter that correspond to the distance advancement and/or the position of the sensor relative to the measurement object,
characterised in that
a plausibility test is carried out in which a signal is generated as a function of the result of the plausibility test and that the deviation of the counter values from the actual position of the optical sensor is used as a measure of the presence of a fault.

24. The method according to claim 23,
characterised in that
an optical and/or acoustic signal display takes place.

25. The method according to claim 23,
characterised in that
an optical sensor using the image processing method calculates the values for the at least one counter from the correlation of at least two temporally successive images.

26. The method according to claim 23,
characterised in that
the positions of the reference markings are filed in a value table and the value table is used for carrying out the plausibility test.

27. The method according to claim 26,
characterised in that
at least the current, measured position of the optical sensor relative to the measurement object is compared to positions in the value table during the plausibility test.

28. The method according to claim 23,
characterised in that
the plausibility test is carried out periodically over time, periodically after a specific distance advancement of the sensor and/or on recognition of a reference mark.

29. The method according to claim 23,
characterised in that
the extent of the deviation can be variably set for recognising a fault.

30. The method according to claim 23,
characterised in that
the reference markings are assigned in a teach-in method to counter values and/or positions filed in a value table.

31. The method according to claim 23,
characterised in that
the result of the plausibility test is transmitted via digital outputs.

32. The method according to claim 23,
characterised in that
the reference markings are arranged linearly and/or in a two-dimensional point raster and/or are formed as line rasters.

33. The method according to claim 23,
characterised in that
the reference markings are additionally coded, in particular uniquely coded.

34. The method according to claim 23,
characterised in that
the images of a reference marking that are determined by an optical sensor are transmitted to additional internal and/or external evaluation means for reference marking recognition.

35. The method according to claim 23,
characterised in that
the reference markings cause a significant alteration of the amount of light and/or light intensity measured by the optical sensor and are recognised as reference markings by the optical sensor via the change in the amount of light or light intensity.

36. The method according to claim 23, characterised in that
the reference markings have light-reflecting, in particular mirroring surface regions and/or surface regions which strongly absorb and/or transmit light.

37. A device for contactlessly measuring lengths and/or speeds of a measurement object, in particular for carrying out positioning tasks, comprising at least one optical sensor, the optical sensor carrying out a contactless length and/or speed measurement, wherein the optical sensor can be used to carry out an image processing method, a spatial frequency filtering method or a laser Doppler method for length and/or speed measurement, and evaluation means being provided that allow reference markings to be recognised, in particular for carrying out a method according to claim 1, wherein evaluation means are provided that provide at least one counter, the values of which correspond to the distance advancement and/or the position of the sensor relative to the measurement object,
characterised in that
the evaluation means can be used to carry out a plausibility test, the deviation of the counter values from the actual position of the optical sensor is used as a measure of the presence of a fault and that a signal can be generated as a function of the result of the plausibility test.

38. The device according to claim 37,
characterised in that
an optical and/or acoustic fault display is provided.

39. The device according to claim 37,
characterised in that
positions of reference markings can be calculated from the counter values via the evaluation means and be filed in a value table.

40. The device according to claim 37,
characterised in that
a plausibility test, in which at least the respective position is compared to positions filed in the value tables, can be carried out via the evaluation means.

41. The device according to claim 37,
characterised in that
at least one digital output is provided.

42. The device according to claim 37,
characterised in that
reference markings are provided that cause a significant alteration of the amount of light or light intensity measured by the optical sensor, and the reference markings can be recognised by the evaluation means via the change in the amount of light or light intensity.

43. The device according to claim 37,
characterised in that
coded, in particular uniquely coded reference markings are provided.
